(19) United States
(12) Patent Application Publication
(10) Pub. No.: US 2012/0171424 A1
(43) Pub. Date: Jul. 5, 2012

(54) COMPOSITE MATERIAL PART WITH REINFORCED AREAS AND MANUFACTURING PROCEDURE

(75) Inventors: Manuel Recio Melero, Madrid (ES); Jose Orencio Granado Macarrilla, Madrid (ES); Vicente Martinez Valdegrama, Madrid (ES)

(73) Assignee: AIRBUS OPERATIONS S.L., Madrid (ES)

(21) Appl. No.: 13/152,071

(22) Filed: Jun. 2, 2011

(30) Foreign Application Priority Data
Dec. 29, 2010 (ES) ES201031986

(51) Int. Cl. B32B 3/00; B32B 37/14

(52) U.S. Cl. 428/156; 156/60

(57) ABSTRACT

Procedure for the manufacture of a composite material part (11) having, at least, one reinforced area (13) of greater thickness than the surrounding areas, in which the dimensions and laying up sequence of the plies (21, 21′, 21″, 21′″) that are used in the laying up step of said reinforced area (13), are determined so that, at least one of the plies (21′, 21″, 21′″) crosses over the ply situated beneath it for reducing the volume of said reinforced area (13). The invention also refers to a composite material part (11) manufactured with said procedure, particularly a CFRP skin of an aircraft lifting surface.

### CROSS-REFERENCE TO RELATED APPLICATION

The present application claims priority to pending Spanish Patent Application No. ES 201031986, filed Dec. 29, 2010, the contents of which are incorporated by reference in its entirety.

### FIELD OF THE INVENTION

The present invention refers to a composite material part with reinforced areas, particularly to an aircraft lifting surface skin with reinforced areas and to a procedure for its manufacture.

### BACKGROUND OF THE INVENTION

As is well known, the aeronautical industry requires structures which, on the one hand, support the loads to which they are submitted, meeting high stiffness and stress requirements and, on the other hand, are as light as possible. A consequence of this is the increased use of composite materials, especially CFRP (Carbon Fibre Reinforced Plastic), in primary structures due to the significant weight loss achieved compared with metallic materials.

Following this trend, there are known, for example, aircraft lifting surfaces which consist of two torsion boxes (on the right hand and left hand sides) joined to a central box manufactured entirely with CFRP panels, using as skins for said boxes individual pieces, that is to say, using four complete skins (two skins on top and two on the bottom) to make up the left hand and right hand torsion box.

These skins have a complex geometry and a variable thickness to meet the different structural requirements of the different areas of the part. They particularly include locally reinforced areas of a greater thickness than the surrounding areas which, by using conventional manufacturing processes, have ramp shaped edges.

These reinforced areas with ramp shaped edges represent a bigger volume to that necessary in strict terms of resistance, which translates into both a weight excess and a design conditioning factor for the lifting surface as they prevent the utilization of the space occupied by said edges as, for example, a union area with other components of the lifting surface.

The present invention is oriented towards solving this problem.

### SUMMARY OF THE INVENTION

It is an object of the present invention to provide a composite part having reinforced areas of greater thickness than its surrounding areas minimizing the volume of said reinforced areas.

It is another object of the present invention to provide a composite part having reinforced areas of greater thickness than its surrounding areas without ramps in at least one of its edges for avoiding interferences with other components of the part desirable located in the vicinity of said reinforced areas.

In one aspect these and other objects are met by a procedure for the manufacture of a composite material part having, at least, one reinforced area of greater thickness than the surrounding areas, in which the dimensions and laying up sequence of the plies that are used in the laying up step of said reinforced area are determined so that, at least, one of the plies crosses over the ply situated beneath it so as to reduce the volume of said reinforced area.

In a preferred embodiment, all the plies of said reinforced area, with the exception of the first ply, cross over the ply situated beneath each one along, at least, one of the edges of the reinforced area. Hereby it is achieved a composite part having a reinforced area without a ramp in at least one of its edges.

In another aspect, the above mentioned objects are met by a composite material part with, at least, one reinforced area of greater thickness than the surrounding areas, which is manufactured according to the above mentioned manufacturing procedure.

In a preferred embodiment said composite material part belongs to the skin of an aircraft lifting surface. Hereby it is achieved a composite material part such as an aircraft wing optimized in weight.

In another preferred embodiment, at least one of the edges of said reinforced area of said aircraft lifting surface is located in the vicinity of a desirable area for the union with another component. Hereby it is achieved an aircraft lifting surface such as en aircraft wing with an improved structural design.

Other characteristics and advantages of the present invention will be clear from the following detailed description of embodiments illustrative of its object in relation to the attached figures.

### DESCRIPTION OF THE FIGURES

FIG. 1 is a schematic plan view of the ply laying up sequence in a reinforced area of a composite material part according to the prior art and FIG. 1a is a schematic view of the cross section of FIG. 1 along the plane A-A.

FIG. 2 is a schematic plan view of the ply laying up sequence in a reinforced area of a composite material part according to an embodiment of the present invention and FIG. 2a is a schematic view of the cross section of FIG. 2 along the plane B-B.

FIG. 3 is an illustrative view of the weight reduction achieved by the part shown in FIG. 2.

FIGS. 4 and 5 are illustrative views of the different relative positions of the reinforced area in the parts shown in FIGS. 1 and 2 in relation to a desirable union area with other elements.

FIGS. 6 and 7 are schematic plan views of the ply laying up sequence in a reinforced area of a composite material part according to other embodiments of the present invention

FIGS. 8 and 9 are partial plan views of a CFRP aircraft skin with reinforced areas according to the present invention.

### DETAILED DESCRIPTION OF THE INVENTION

Processes for manufacturing parts of a composite material, particularly CFRP, comprising basically a first laying up step and a second consolidation step are well known in the aeronautic industry.

Layers of a composite material such as the prepreg, which is a mixture of fibrous reinforcement and polymeric matrix which is able to be stored, are placed in a suitably shaped mandrel in the laying up step.

This material can be in several forms and particularly in the form of plies. Resin is generally partially cured or is taken to a controlled viscosity by means of another process called B-step for thermosetting matrices.

The composite material plies are not placed randomly, but rather they are arranged in each area in a certain number and with a certain orientation of their fibrous reinforcement, typically carbon fiber, determined according to the nature and magnitude of the stresses which the piece will support in each area.

Each area has thus the structure determined by its ply arrangement or stacking. The difference in thickness between the different areas generates plies drop-offs, which requires having a ply model for each part clearly establishing how it must be arranged on the mandrel during the stacking process. The final result is a planar laminate with areas of different thickness.

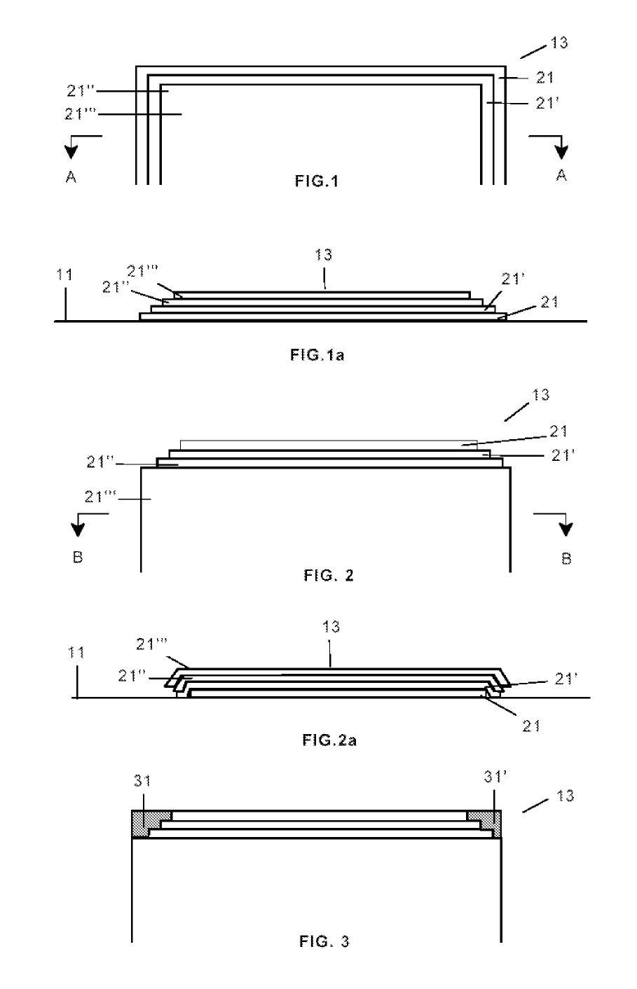

FIGS. 1 and 1a illustrate the laying up of a reinforced area 13 of a part 11 according to the prior art. The dimensions and laying up sequence of the plies 21, 21′, 21″, 21′″ are chosen for the formation of ramp shaped edges in the reinforced areas, or, in other words, so that the reinforced areas have a frusto pyramidal shape. On that score, it has been deemed necessary in the manufacturing of composite material parts, that the “death” or “drop off” of a ply in a ramp should be produced on top of another ply, in other words, that there be no cross over between plies.

The inventors of the present application have found that, contrary to prior understandings in the design of composite parts, it is possible to manufacture a part 11 with plies 21, 21′, 21″, 21′″ for a reinforced area 13 with the dimensions and laying up sequence illustrated in FIGS. 2 and 2a in which each ply crosses over the ply situated beneath it.

The present invention allows therefore obtaining a weight reduction in said reinforced areas, as is illustrated in FIG. 3, in which the shaded areas 31, 31′ represent the “liberated” areas using the manufacturing procedure according to this invention in relation to the part shown in FIG. 1.

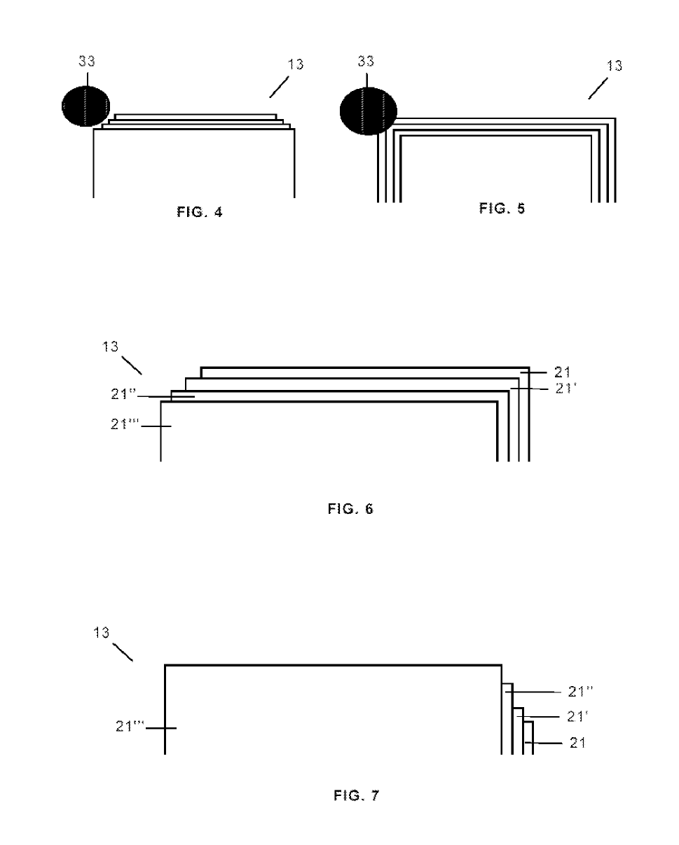

By comparing FIGS. 4 and 5 it can be seen that the present invention allows the utilization of an area 33 close to the reinforced area 13 as a union area of the part 11 with another component, which was not possible with a reinforced area 13 manufactured according to the prior art.

In the embodiment of the present invention illustrated in FIG. 2, each of the plies 21′, 21″, 21′″ crosses over the ply situated beneath it along the left hand and right hand edges of the reinforced area 13.

FIG. 6 shows another embodiment in which each of the plies 21′, 21″, 21′″ crosses over the ply situated beneath it only along the left hand edge of the reinforced area 13.

FIG. 7 shows another embodiment in which each of the plies 21′, 21″, 21′″ crosses over the ply situated beneath it along the upper and right hand side edges of the reinforced area 13.

In general terms, the present invention comprises parts 11 with at least one reinforced area 13, in which some of its plies cross over the ply situated beneath it at least by one of its edges and the illustrative embodiments in FIGS. 2, 6 and 7 only pretend to illustrate three possible options for the design of reinforced areas in composite material parts made up with “cross over” plies.

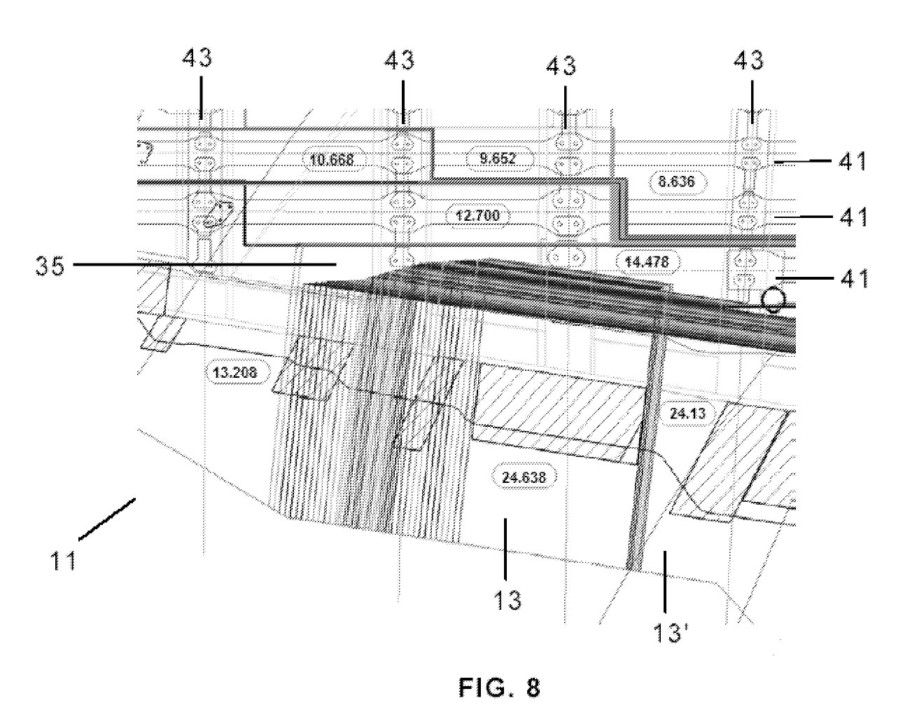

As an example of an embodiment of this invention, FIG. 8 shows a plan view of a zone of an aircraft wing 11 with areas of different thickness indicated by numerals. In particular there are two reinforced areas 13, 13′ having, respectively, a thickness of 24.638 and 24.13 mm near an area 35 of thickness 14.478 mm where an stringer 41 and several ribs 43 end. The plies of said reinforced areas 13, 13′ crosses over the ply situated situated beneath along the edge facing the area 35 for reducing its volume. Otherwise said said end of stringer 41 and ribs 43 could not be located in the area 35.

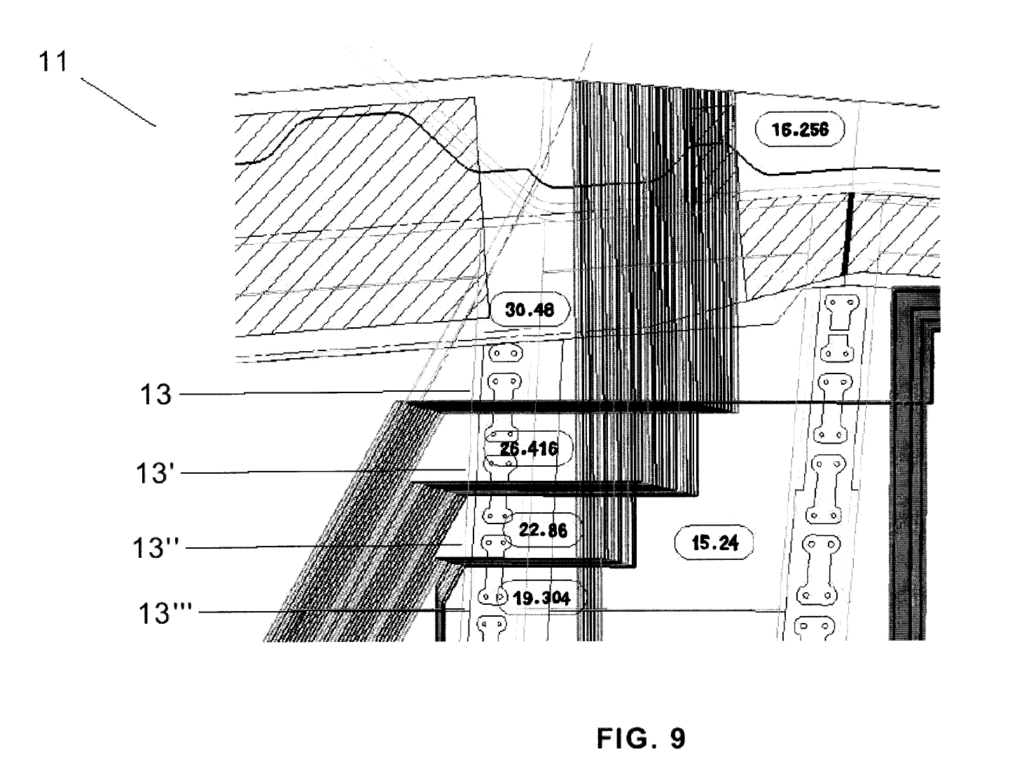

Another example is shown in FIG. 9 where the part 11 has four reinforced areas 13, 13′, 13″, 13′″ having, respectively, a thickness of 30.48, 26.416, 22.86, 19.304 mm where the plies crosses over the ply situated beneath along the edges between them.

As the skilled man will readily understand, the present invention is applicable to the manufacture of any part which has reinforced areas similar to those of the skins of aircraft lifting surfaces.

Although the present invention has been fully described in connection with preferred embodiments, it is evident that modifications may be introduced within the scope thereof, not considering this as limited by these embodiments, but by the contents of the following claims.

1. Procedure for the manufacture of a composite material part (11) having, at least, one reinforced area (13) of greater thickness than the surrounding areas, characterized by the fact that the dimensions and laying up sequence of the plies (21, 21′, 21″, 21′″) that are used in the laying up step of said reinforced area (13), are determined so that, at least one of the plies (21′, 21″, 21′″) crosses over the ply situated beneath it for reducing the volume of said reinforced area (13).

2. Procedure for the manufacture of a composite material part (11) according to claim 1, wherein, with the exception of the first ply (21), all the plies (21′, 21″, 21′″) of said reinforced area (13) cross over the ply situated beneath each one, along, at least, one of the edges of the reinforced area (13).

3. Composite material part (11) with, at least, one reinforced area (13) of greater thickness than the surrounding areas, characterized by the fact that it is manufactured according to the procedure of claim 1.

4. Composite material part (11) with, at least, one reinforced area (13) of greater thickness than the surrounding areas, characterized by the fact that it is manufactured according to the procedure of claim 2.

5. Composite material part (11) according to claim 3, characterized by the fact that it belongs to the skin of an aircraft lifting surface.

6. Composite material part (11) according to claim 4, characterized by the fact that it belongs to the skin of an aircraft lifting surface.

7. Composite material part (11) according to claim 5, characterized by the fact that at least one of the edges of said reinforced area (13) is located in the vicinity of a desirable area (35) for the union with another component.

8. Composite material part (11) according to claim 6, characterized by the fact that at least one of the edges of said reinforced area (13) is located in the vicinity of a desirable area (35) for the union with another component.
